(19) United States
(12) Patent Application Publication
(10) Pub. No.: US 2005/0153739 A1
(43) Pub. Date: Jul. 14, 2005

(54) Receive and send fax services for mobile device

(75) Inventor: Victoria M. Halsell, Aurora, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/753,243

(22) Filed: Jan. 8, 2004

(51) Int. Cl. H04M 1/00

(52) U.S. Cl. 455/557

(57) ABSTRACT

A mobile device for receiving and rendering an incoming fax message and for sending an outgoing fax message is provided as well as associated fax receiving and sending methods. The receiving method includes: a) receiving the incoming fax message from a calling party via a wireless network, b) activating a user cue, c) displaying information about the incoming fax message on a graphical user interface, and d) communicating the incoming fax message to an external rendering device via an output port. The sending method includes: a) storing one or more data files in a first storage device associated with the mobile device, b) generating an outgoing fax message including at least one data file from the one or more data files in the first storage device and initiating an outgoing call via the wireless network to a recipient, and c) sending the outgoing fax message to the recipient.

### BACKGROUND OF INVENTION

The invention generally relates to fax services for mobile devices and associated methods for receiving and sending faxes via a mobile device associated with a wireless network and will be described with particular reference thereto. However, it is to be appreciated that the invention is also amenable to other applications.

Today, when a fax needs to be sent there are only a few practical options. For example, 1) send the fax to another fax machine, 2) send it to a voicemail service, where it is readable via PC or can be sent to a rendering device after logging in, or 3) send it directly to a PC.

Wireless networks can transmit data (e.g., short message service (SMS)) to and from mobile devices and can even receive faxes. However, sending a fax to a mobile device is not practical because a method does not exist for rendering the fax in a human-readable form. Moreover, a fax to a mobile device cannot be stored either locally within the mobile device or centrally within a wireless network associated with the mobile device. Similarly, a method does not exist for a mobile device to upload a document and send a fax via the wireless network.

As can be appreciated from the foregoing, mobile devices cannot adequately render a fax in human-readable form nor can they upload and send a fax. Thus, there is motivation for a mobile device that can render a fax in human-readable form, store a fax, upload and send a fax, or any combination thereof. Additionally, there is motivation for a wireless network device that can store a fax to a mobile called party.

### BRIEF SUMMARY OF INVENTION

In one aspect of the invention, a method for a mobile device to receive and render an incoming fax message is provided. The method includes: a) receiving an incoming fax message from a calling party via a wireless network, b) activating a user cue to notify a user associated with the mobile device the incoming fax message was received, c) in response to user interaction with the mobile device, displaying information about the incoming fax message on a graphical user interface, and d) in response to user interaction with the mobile device, communicating the incoming fax message to an external rendering device via an output port.

In another aspect of the invention, a method for a mobile device to send an outgoing fax message is provided. The method includes: a) storing one or more fax contents in a first storage device associated with the mobile device, b) in response to user interaction with the mobile device, generating an outgoing fax message including at least one selected fax content from the one or more fax contents stored in the first storage device and initiating an outgoing call via a wireless network associated with the mobile device to a recipient of the outgoing fax message, and c) after the recipient answers the call, sending the outgoing fax message to the recipient.

In still another aspect of the invention, a mobile device for receiving and rendering an incoming fax message via a wireless network and for sending an outgoing fax message via the wireless network is provided. The mobile device includes: means for receiving an incoming fax message from a calling party via the wireless network, a controller in communication with the receiving means to control the mobile device, a user cue in communication with the controller to notify a user associated with the mobile device that the incoming fax message was received, a keypad in communication with the controller to acknowledge receipt of the incoming fax message, means for activating and de-activating the user cue in response to operation of the receiving means and keypad, a graphical user interface in communication with the controller to display information about the incoming fax message, and an output port in communication with the receiving means and controller for communicating the incoming fax message to an external rendering device via the output port.

Benefits and advantages of the invention will become apparent to those of ordinary skill in the art upon reading and understanding the description of the invention provided herein.

### BRIEF DESCRIPTION OF DRAWINGS

The invention is described in more detail in conjunction with a set of accompanying drawings.

FIG. 1 is a block diagram of an exemplary telecommunication network in which a mobile device may receive a fax from a faxing device or send a fax to the faxing device via a wireless network.

FIG. 2 is a block diagram of an exemplary mobile device incorporating receive and send fax features.

FIG. 3 is a flowchart of an exemplary process for a mobile device to receive an incoming fax via a wireless network.

FIG. 4 is a flowchart of an exemplary process for a mobile device to receive fax content from a scanning device for, for example, subsequent inclusion in an outgoing fax.

FIG. 5 is a flowchart of an exemplary process for a mobile device to render a fax to a rendering device and/or send an outgoing fax via a wireless network.

FIG. 6 is a flowchart of an exemplary process for a mobile device to receive and view a new fax stored on a wireless network.

FIG. 7 is a flowchart of an exemplary process for a mobile device to render a fax stored on a wireless network.

### DETAILED DESCRIPTION

While the invention is described in conjunction with the accompanying drawings, the drawings are for purposes of illustrating exemplary embodiments of the invention and are not to be construed as limiting the invention to such embodiments. It is understood that the invention may take form in various components and arrangement of components and in various steps and arrangement of steps beyond those provided in the drawings and associated description. In the drawings, like reference numerals denote like elements and similar reference numerals denote similar elements.

In general, the invention provides an internal receive and send fax services for a mobile device. In one embodiment, the mobile device is used to accept faxes with any number of pages in an incoming call via a wireless network, store the fax, and render (e.g., print, display, etc.) the fax via an output port to any rendering device (e.g., printing device, fax reader, display device, etc.). In another embodiment, the wireless network stores the fax. In still another embodiment, the mobile device is used to accept data via an input port from any scanning device, store the data, and send the data as a fax to a recipient in an outgoing call via a wireless network. In this embodiment, the mobile device may also render the data via the output port to any rendering device.

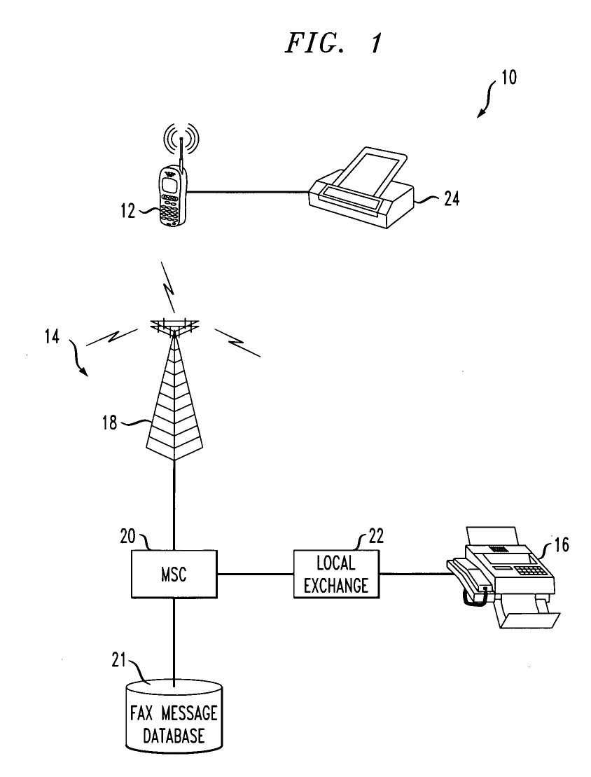

With reference to FIG. 1, in an exemplary embodiment of a telecommunication network 10, a faxing device 16 can send a fax via a wireless network 14 to a mobile device 12. In other words, the mobile device 12 can receive a fax from the faxing device 16 via the wireless network 14. The mobile device 12 can then render the fax to a multi-function device (e.g., rendering and scanning device) 24. Similarly, the mobile device 12 can send a fax to the faxing device 16 via the wireless network 14. Prior to sending, the fax content may initially be uploaded by the mobile device 12 from the multi-function device 24. As shown, the wireless network 14 includes a base station 18, a mobile switching center (MSC) 20, and a fax message database 21. In practice, the wireless network also includes other components, such as a home location register (HLR). The fax message database 21 is optional and may be part of a service node, application database, or incorporated within the MSC or HLR. The telecommunication network also includes a local exchange 22 in communication with the wireless network 14 and the faxing device 16. As shown, the multi-function device 24 is in operative communication with the mobile device 12. In another embodiment, a rendering device and a scanning device may be provided separately in place of the multi-function device 24. The rendering device is used in conjunction with fax receiving services. The scanning device is used in conjunction with fax sending services. Thus, in further embodiments, any one of the rendering device or scanning device may be provided if only fax receiving or only fax sending is desired. In still further embodiments, the faxing device 16 can be a mobile device with fax features like mobile device 12 described herein. If so, the local exchange 22 is replaced with a wireless network similar to wireless network 14 described herein.

The mobile device 12 will accept a fax via the wireless network 14 in an incoming call from the faxing device 16. The wireless network 14 knows that a particular call is a fax call based on the media type that is included in the signaling at the bearer level. This signaling indicates whether the media type is voice, fax, dtmf (digits), etc. Fax calls are treated as data calls (e.g., SMS). As an example, a wireless network can be used as a transport network (network B in a “A calls C configuration,” where B is needed as a hop network in between A and C). If a call comes in destined for network C, network B (i.e., the wireless network) can recognize it as a fax call and make the appropriate modifications at the bearer level (e.g., with echo cancellation, etc.) and then pass the call to C. This type of configuration is based on business arrangements in place between the pertinent service providers.

The wireless network 14 stores the fax in the fax message database 21 and the mobile device 12 notifies a user that a new fax has been received. Next, the user may connect the mobile device 12 to any rendering device and render the fax. Via a graphical user interface (GUI) (e.g., display device, LCD screen, etc.) on the mobile device 12, the user can selectively render one or more pages. The mobile device, for example, can be connected via a USB connection or equivalent cable connection to any rendering device. In an alternate embodiment, the mobile can communicate with the rendering device via a wireless interface, such as wireless fidelity (WiFi) (i.e., IEEE 802.11), laser, or infrared (IR). In another alternate embodiment, the mobile device 12 can store the fax in a storage device within the mobile device. Storage of the fax within the mobile device may preclude the need for the wireless network to store the fax and may eliminate the need for the fax message database 21.

Once the faxed document is rendered, the user can make changes to the document, for example, adding a handwritten signature, comments, or annotations. The user can then use a scanning device to scan the changed document. The user can then establish a connection between the scanning device and the mobile device 12 to receive or upload the changed document back to the mobile device 12. Then, the user can send the changed document back to the original sending party (or another party) as an outgoing fax message via the wireless network 14. In the embodiment being described, the scanning device is incorporated within the multi-function device 24.

The mobile device 12 includes settings to allow it to accept incoming data from an external peripheral (i.e., multi-function device 24 or any type of scanning device, as opposed to the wireless network 14). While connected to the scanning device, the mobile phone 12 can accept the data, store the data, and optionally compress the data. Via the GUI, the user can select the data to be sent in the outgoing fax message, enter the directory number (DN) of the faxing device 16 (i.e., destination or fax recipient), and initiate a call to the faxing device 16. The mobile device 12 communicates the fax message to the faxing device 16 via the wireless network 14 and local exchange 22.

In an example fax receive scenario, USER A is notified that an important fax needs to be sent to him right away. USER A is out of the office and not near a PC or fax machine, so he/she requests that the fax be sent to his/her mobile device 12. Subsequently, the fax is sent to USER A's mobile device 12. The wireless network 14 sends the fax to the mobile device 12 and, via messaging, the fax is stored in the mobile device 12. Optionally, the fax could be stored in the fax message database 21 until it is ready to be rendered. Of course, storing the fax in the mobile device 12 removes any dependence on the wireless network 14 for rendering the fax using the mobile device 12. In other words, even if there is no wireless signal available, the user can render the fax from the mobile device 12 after it is stored within the mobile device 12.

After the fax is received, USER A gets a notification that a fax was received and may be accessed from a certain storage device. The GUI is too small and the fax is too large to view in human-readable form on the mobile device, so USER A connects the mobile device to a rendering device in, for example, a coffee shop (or other location), via, for example, a USB connection and then renders the fax. USER A may read the rendered fax and subsequently delete it from the storage device.

In an example fax send scenario, USER A has received a fax via the mobile device 12, connected the mobile device 12 to a rendering device, and rendered the fax on the rendering device. USER A realizes that the faxed document includes a signature block and the sending party has requested that the fax be signed and returned immediately. USER A signs the faxed document. Instead of trying to locate a fax machine, USER A connects the mobile device 12 to a scanning device and scans the signed document.

The rendering device and scanning device may be combined as shown in the multi-function device 24 of FIG. 1. If so, USER A connects to the multi-function device 24 to render the faxed document and returns to the multi-function device 24 to scan the signed document. Once the signed document is scanned, USER A can select the scanned data to be transferred or uploaded from the scanning device to the mobile device 12 via the same USB connection. The data, including the original faxed document and signature, is then stored in the mobile device 12. In one embodiment, the user may elect to overwrite the faxed document that is already stored to save storage space. Optionally, the mobile device 12 may perform a comparison of the scanned document to the faxed document and save processing power by only updating the differences between the documents. USER A can select the scanned document and send it to the original calling party in an outgoing fax message to the faxing device 16 via the wireless network 14 and local exchange 22.

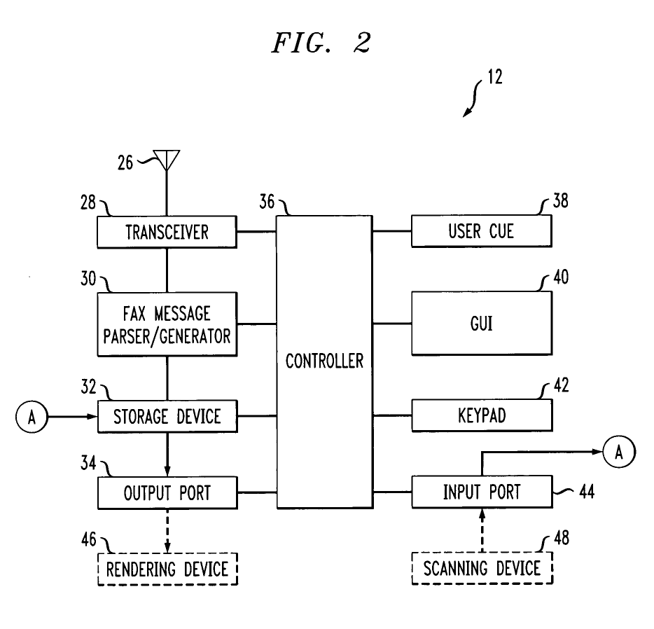

With reference to FIG. 2, an exemplary embodiment of a mobile device 12 incorporating receive and send fax features includes an antenna 26, a transceiver 28, a fax message parser/generator 30, a storage device 32, an output port 34, a controller 36, a user cue 38, a GUI 40, a keypad 42, and an input port 44. The mobile device 12 can communicate with an external rendering device 46 via the output port 34 and an external scanning device 48 via the input port 44. The input port 44 is for uploading a scanned document from the external scanning device 48. The uploaded document is stored in the storage device 32 and ultimately sent to a recipient via the wireless network 14 (FIG. 1). The output port 34 is for communicating a faxed or scanned document to the external rendering device 46 for rendering after it was received by the mobile device 12. The output port 34 and input port 44 may be provided through a common port or interface and the rendering device 46 and scanning device 48 may be provided through the multi-function device 24 (FIG. 1). In an embodiment of the mobile device incorporating only receive fax features, the transceiver 28 may be replaced by a receiver, the fax message parser/generator 30 does not require generator capabilities, and the input port 44 is not required. In an embodiment of the mobile device incorporating only send fax features, the transceiver 28 may be replaced by a transmitter, the fax message parser/generator 30 does not require parser capabilities, and the output port 46 is not required.

The controller 36 is in communication with the receiver 28, fax message parser/generator 30, storage device 32, output port 34, user cue 38, GUI 40, keypad 42, and input port 44 and controls overall operation of the mobile device 12 by coordinating operation of these components. The antenna 26 provides the mobile device 12 with a communication interface to the wireless network 14 (FIG. 1). The antenna 26 is in communication with the transceiver 28 and, in combination with the transceiver 28, receives incoming calls from the wireless network 14 (FIG. 1) and transmits outgoing calls to the wireless network 14 (FIG. 1). The transceiver 28 is in communication with the fax message parser/generator 30. The transceiver 28 communicates incoming fax messages to the fax message parser/generator 30 and receives outgoing fax messages from the fax message parser/generator 30 for transmission to the wireless network 14 (FIG. 1) via the antenna 26.

The fax message parser/generator 30 parses incoming fax messages into commands and instructions that are acted upon by the controller 36 and fax content which is stored in the storage device 32. The fax message parser/generator 30 generates outgoing fax messages under control of the controller 36. The outgoing fax messages generated by the fax message parser/generator 30 include commands and instructions and fax content retrieved from the storage device 32. The storage device 32 may include any suitable storage device, including internal memory. The storage device 32 is in communication with the output port 34 and the input port 44. The storage device 32 communicates stored fax content to the rendering device 46 via the output port 34 and receives data to be stored as fax content from scanning device 48 via the input port 44.

The mobile device 12 is controlled by a user via the keypad 42. The keypad 42 may include standard mobile keys, special keys, or any combination of standard and special keys. The mobile device 12 informs the user of certain conditions within the mobile device via the user cue 38 and GUI 40. The user cue 38 may include an audible cue, a visual cue, and/or a vibratory cue. The audible cue may be any type of audible tone or tone sequence. The visual cue may be any form of illuminated indicator and may be incorporated within the GUI. The visual cue may include flashing, color variation, and/or intensity variation. The vibratory cue may include any type of vibration sequence. The controller 36 activates the user cue 38 to notify the user that a new incoming fax message has been received. Once the user has acknowledged receipt of the new incoming fax message by viewing information about the new fax and/or the fax content, the controller 36 deactivates the user cue 38.

The GUI 40 may include a display monitor capable of displaying, for example, text, icons, and other images. Fax content may be displayed on the GUI 40, but it is not large enough to display normal text fonts in human-readable form. The user can use the keypad 42 and GUI 40 in combination to view a list of stored fax content, select stored fax content, and communicate the stored fax content in an outgoing fax message via the antenna 26 or to the rendering device 46 via the output port 34. Similarly, the user can use the keypad 42 and GUI 40 in combination to select a fax message for rendering to the rendering device 46 via the output port 34 or select scanned data to be uploaded from the scanning device 48 via the input port 44.

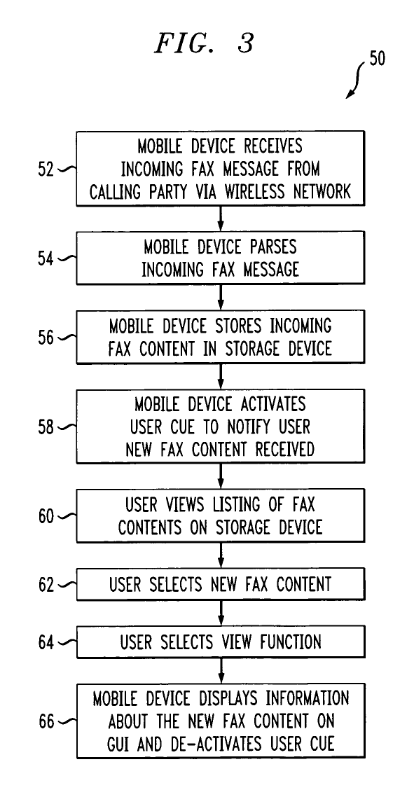

With reference to FIG. 3, an exemplary embodiment of a process 50 for a mobile device to receive an incoming fax message via a wireless network begins at step 52 where the mobile device receives an incoming fax message from a calling party via the wireless network. Next, the mobile device parses the incoming fax message to separate out the fax content (step 54). At step 56, the mobile device stores the incoming fax content in a storage device. Next, the mobile device activates a user cue to notify a user associated with the mobile device that new fax content has been received (step 58). At step 60, the user uses a keypad and GUI associated with the mobile device to view a listing of one or more fax contents stored on the storage device. Next, the user uses the keypad and GUI to select one or more new fax content items from the listing (step 62). At step 64, the user uses the keypad and GUI to select a view function. Next, the mobile device displays information about the new fax content on the GUI and de-activates the user cue (step 66). In this step, the mobile device may optionally display the new fax content on the GUI. However, due to the size and resolution of the GUI, the normal text fonts in the new fax content are not in human-readable form. The process 50 being described may be implemented in software, hardware, or combinations thereof within various components of the mobile device 12 (FIGS. 1 and 2), including software within the controller 36 (FIG. 2).

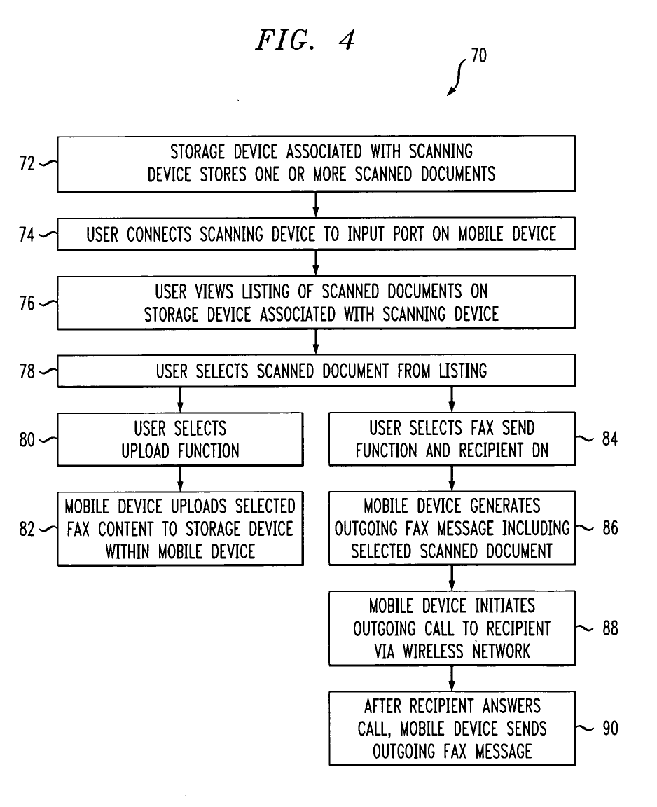

With reference to FIG. 4, an exemplary embodiment of a process 70 for a mobile device to receive data from a scanning device for, for example, subsequent inclusion in an outgoing fax begins at step 72 where a storage device associated with an external scanning device stores one or more scanned documents. The storage device associated with the scanning device may include memory, a fixed disk storage device, a removable disk storage device and corresponding removable disk, or any other type of suitable storage device. The scanning device may be a scanner, a multi-function device, a computer system in communication with a scanner, or any suitable scanning device. Next, a user associated with the mobile device connects the scanning device to an input port on the mobile device (step 74). At step 76, the user uses a keypad and GUI associated with the mobile device to view a listing of one or more scanned documents stored on the storage device associated with the scanning device. Next, the user uses the keypad and GUI to select one or more of the scanned documents from the listing (step 78).

After step 78, the user may select an upload function using the keypad and GUI (step 80). At step 82, the mobile device uploads the selected scanned document(s) to a storage device within the mobile device.

After step 78, the user may also select a fax send function and identify a recipient DN using the keypad and GUI (step 84). At step 86, the mobile device generates an outgoing fax message including the selected scanned document(s). Next, the mobile device initiates an outgoing call to the recipient via a wireless network (step 88). At step 90, after the recipient answers the call, the mobile device sends the outgoing fax message to the recipient. The process 70 being described may be implemented in software, hardware, or combinations thereof within various components of the mobile device 12 (FIGS. 1 and 2), including software within the controller 36 (FIG. 2).

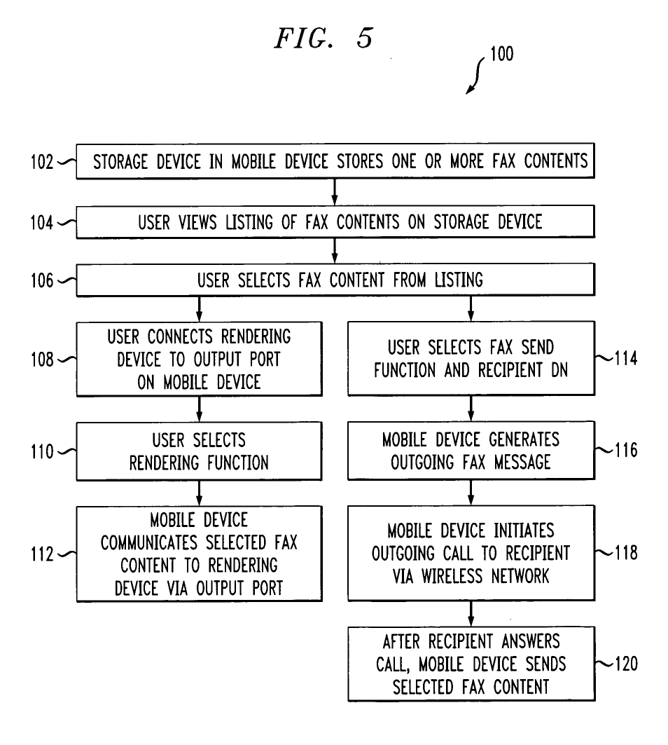

With reference to FIG. 5, an exemplary embodiment of a process 100 for a mobile device to render a fax content to a rendering device and/or send an outgoing fax message via a wireless network begins at step 102 where a storage device in the mobile device stores one or more fax contents. Next, a user uses a keypad and GUI associated with the mobile device to view a listing of the one or more stored fax contents (step 104). At step 106, the user uses the keypad and GUI to select one or more of the fax contents from the listing.

After step 106, the user may connect an external rendering device to an output port on the mobile device (step 108). At step 110, the user selects a render function using the keypad and GUI. Next, the mobile device communicates the selected fax content in a data stream to the rendering device via the output port (step 112).

After step 106, the user may also select a fax send function and identify a recipient DN using the keypad and GUI (step 114). At step 116, the mobile device generates an outgoing fax message including the selected fax content. Next, the mobile device initiates an outgoing call to the recipient via a wireless network (step 118). At step 120, after the recipient answers the call, the mobile device sends the outgoing fax message to the recipient. The process 100 being described may be implemented in software, hardware, or combinations thereof within various components of the mobile device 12 (FIGS. 1 and 2), including software within the controller 36 (FIG. 2).

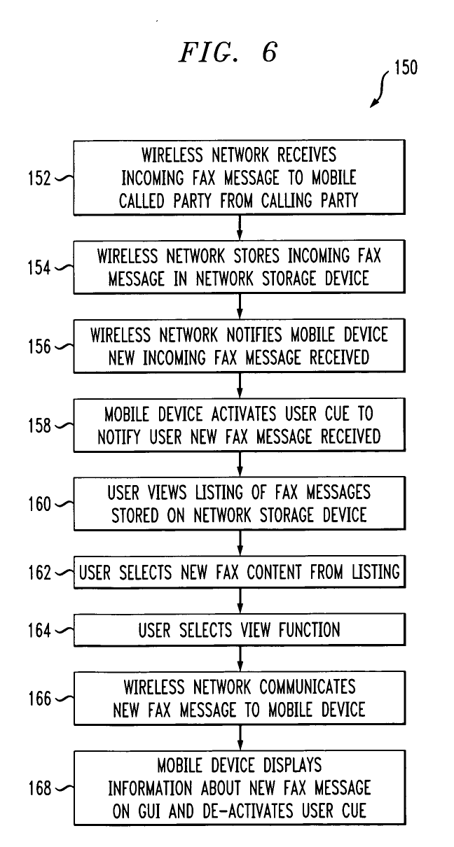

With reference to FIG. 6, an exemplary embodiment of a process 150 for a mobile device to receive and view a new fax content stored on a wireless network begins at step 152 where the wireless network receives an incoming fax message to a mobile called party from a calling party. Next, the wireless network stores the incoming fax message in a storage device (e.g., fax message database 21 (FIG. 1)) associated with the wireless network (step 154). At step 156, the wireless network notifies (e.g., pages) the mobile device that a new incoming fax message was received. Next, the mobile device activates a user cue to notify a user associated with the mobile device that a new fax message has been received (step 158). At step 160, the user uses a keypad and GUI associated with the mobile device to view a listing of one or more fax messages stored on the storage device associated with the wireless network. Next, the user uses the keypad and GUI to select one or more new fax message items from the listing (step 162). At step 164, the user uses the keypad and GUI to select a view function. Next, the wireless network communicates the selected new fax message to the mobile device (step 166). At step 168, the mobile device displays information about the new fax message on the GUI and de-activates the user cue (step 168). In this step, the mobile device may optionally display the new fax content on the GUI. However, due to the size and resolution of the GUI, the normal text fonts in the new fax content are not in human-readable form. The process 150 being described may be implemented in software, hardware, or combinations thereof within various components of the mobile device 12 (FIGS. 1 and 2) and MSC 20 (FIG. 1), including software within the controller 36 (FIG. 2) and MSC 20 (FIG. 1).

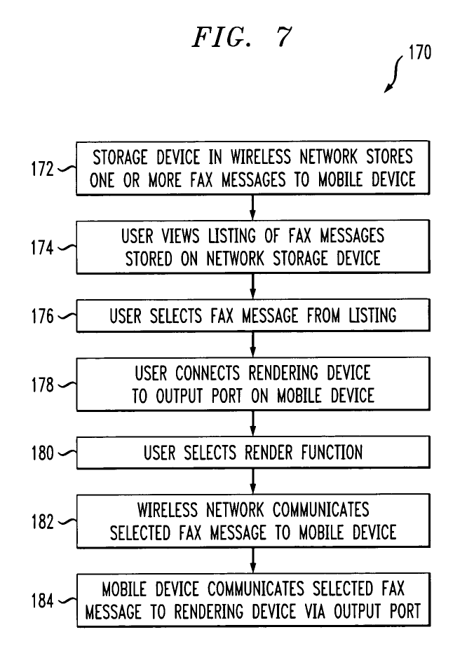

With reference to FIG. 7, an exemplary embodiment of a process 170 for a mobile device to render a fax content stored on a wireless network begins at step 172 where a storage device (e.g., fax message database 21 (FIG. 1)) in a wireless network associated with the mobile device stores one or more fax messages for the mobile device. Next, a user uses a keypad and GUI associated with the mobile device to view a listing of the one or more stored fax messages stored on the storage device associated with the wireless network (step 174). At step 176, the user uses the keypad and GUI to select one or more of the fax messages from the listing. Next, the user connects an external rendering device to an output port on the mobile device (step 178). At step 180, the user selects a render function using the keypad and GUI. Next, the wireless network communicates the selected fax message to the mobile device (step 182). At step 184, the mobile device communicates the selected fax message in a data stream to the rendering device via the output port (step 184). The process 150 being described may be implemented in software, hardware, or combinations thereof within various components of the mobile device 12 (FIGS. 1 and 2) and MSC 20 (FIG. 1), including software within the controller 36 (FIG. 2) and MSC 20 (FIG. 1).

In summary, in one embodiment of the invention, a mobile device may be connected to a rendering device via, for example, a USB connection for quick rendering of a stored fax message. In another embodiment, the mobile device stores a fax message in a storage device (e.g., internal memory) within the mobile device. In still another embodiment, the user can use a GUI on the mobile device to select one or more pages to be rendered.

In still yet another embodiment, the mobile device may be connected to a scanning or multi-function device to accept data to be included in a subsequent fax from the scanning device rather than the wireless network. The mobile device may store the scanned data in a storage device within the mobile device. The user can use the GUI on the mobile device to select the scanned data file and enter the DN of a recipient to which the outgoing fax message is to be sent.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

1. A method for a mobile device to receive and render an incoming fax message, the method including the steps:
a) receiving an incoming fax message from a calling party via a wireless network;
b) activating a user cue to notify a user associated with the mobile device the incoming fax message was received;
c) in response to user interaction with the mobile device, displaying information about the incoming fax message on a graphical user interface; and
d) in response to user interaction with the mobile device, communicating the incoming fax message to an external rendering device via an output port.

2. The method set forth in claim 1 wherein the output port includes at least one of a cable connection, a radio frequency (RF) interface, and an infrared (IR) frequency interface.

3. The method set forth in claim 2 wherein the cable connection is a USB cable connection.

4. The method set forth in claim 2 wherein the RF interface is an IEEE 802.11 interface.

5. The method set forth in claim 1, further including the step:
e) storing the incoming fax message in a storage device within the mobile device.

6. The method set forth in claim 1, further including the step:
e) storing the incoming fax message in a storage device associated with the wireless network.

7. The method set forth in claim 1, between steps b) and c), further including the step:
e) displaying a listing of incoming fax messages for selection by the user.

8. The method set forth in claim 1, further including the step:
e) connecting the external rendering device to the output port;
f) rendering the incoming fax message on the external rendering device.

9. The method set forth in claim 8 wherein the external rendering device includes at least one of a printing device, a fax reader, and a display device.

10. The method set forth in claim 8 wherein the connecting in step e) is accomplished by moving the mobile device or the external rendering device within communicative range of each other.

11. A method for a mobile device to send an outgoing fax message, the method including the steps:
a) storing one or more fax contents in a first storage device associated with the mobile device;
b) in response to user interaction with the mobile device, generating an outgoing fax message including at least one selected fax content from the one or more fax contents stored in the first storage device and initiating an outgoing call via a wireless network associated with the mobile device to a recipient of the outgoing fax message; and
c) after the recipient answers the call, sending the outgoing fax message to the recipient.

12. The method set forth in claim 11, before step a), further including the steps:
d) connecting an external device to an input port on the mobile device; and
e) uploading a data file from a second storage device associated with the external device to the first storage device associated with the mobile device.

13. The method set forth in claim 12 wherein the external device includes a scanning device and the method further includes the step:
f) scanning a document to be included in the outgoing fax message to create the data file; and
g) storing the data file in the second storage device.

14. The method set forth in claim 12 wherein the connecting in step d) is accomplished by moving the mobile device or the external device within communicative range of each other.

15. The method set forth in claim 12 wherein the connecting in step d) is accomplished by connecting a cable between the mobile device and the external device.

16. A mobile device for receiving and rendering an incoming fax message via a wireless network and for sending an outgoing fax message via the wireless network, the mobile device including:
means for receiving an incoming fax message from a calling party via the wireless network;
a controller in communication with the receiving means to control the mobile device;
a user cue in communication with the controller to notify a user associated with the mobile device that the incoming fax message was received;
a keypad in communication with the controller to acknowledge receipt of the incoming fax message;
means for activating and de-activating the user cue in response to operation of the receiving means and keypad;
a graphical user interface in communication with the controller to display information about the incoming fax message; and
an output port in communication with the receiving means and controller for communicating the incoming fax message to an external rendering device via the output port.

17. The mobile device set forth in claim 16, further including:
means for storing one or more fax contents in a first storage device associated with the mobile device.

18. The mobile device set forth in claim 16, further including:
means for storing the incoming fax message in a storage device within the mobile device.

19. The mobile device set forth in claim 16, further including:
means for storing one or more data files in a first storage device associated with the mobile device;
means for generating an outgoing fax message including at least one selected data file from the one or more stored data files stored in the first storage device;
means for initiating an outgoing call via the wireless network to a recipient of the outgoing fax message; and
means for sending the outgoing fax message to the recipient.

20. The mobile device set forth in claim 20, further including:
an input port in communication with the storing means and the controller for uploading the one or more data files from an external device; and
means for uploading the one or more data files from the external device to the storing means via the input port.
